(19) United States
(12) Patent Application Publication
(10) Pub. No.: US 2026/0348163 A1
(43) Pub. Date: Nov. 5, 2026

(54) Modular Pole And Canopy Assembly And Methods For Assembling The Same

(71) Applicant: Marketing Displays, Inc., Farmington Hills, MI (US)

(72) Inventors: Jonathan Luke KLAUTKY, Farmington Hills, MI (US); Brody RODGERS, Canton, MI (US); William David FRISK, JR., South Lyon, MI (US)

(73) Assignee: Marketing Displays, Inc., Farmington Hills, MI (US)

(21) Appl. No.: 19/654,757

(22) Filed: Apr. 22, 2026

Related U.S. Application Data
(60) Provisional application No. 63/798,920, filed on May 2, 2025.

(51) Int. Cl. E04F 10/00; F16M 13/02

(52) U.S. Cl. CPC E04F 10/005; F16M 13/02

(57) ABSTRACT

A modular pole and canopy assembly includes a pole sub-assembly having a first segment and a second segment, the first and second segments being couplable to one another using a sleeve. The modular pole and canopy assembly further includes a canopy sub-assembly including a plurality of framing supports and a plurality of sheets supported by the plurality of framing supports. One or more of the plurality of framing supports is couplable to the first segment of the pole sub-assembly. The plurality of sheets includes a central sheet and two lateral sheets configured to be positioned on opposing sides of the central sheet. The plurality of framing supports includes two lateral support and two major beams. Each of the two major beams is couplable to at least one of the lateral sheets and positioned perpendicularly to each lateral support.

### CROSS-REFERENCE TO RELATED APPLICATIONS

This application claims the benefit of U.S. Provisional Application No. 63/798,920 filed on May 2, 2025. The entire disclosure of the above application is incorporated herein by reference.

### FIELD

The present disclosure relates to modular pole and canopy assemblies and methods for assembling the same.

### BACKGROUND

The background description provided here is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Pole and canopy assemblies provide weather cover and also points of contact for displays and screens for various drive-throughs (such as at fast food restaurants and banks). Pole and canopy assemblies are often shipped and installed in two segments: a single welded pole component and a single welded canopy component. The two segments often require the use of heavy equipment for shipping and installation. The heavy equipment can be difficult to maneuver in urban environments and are generally costly to operate. The welded or unitary construction of the pole and canopy assemblies has been considered necessary for maintaining structural soundness in various weather conditions. It would be desirable to develop modular pole and canopy assemblies that provide sufficient weather resistance but that are easier to transport and assemble.

### SUMMARY

This section provides a general summary of the disclosure, and is not a comprehensive disclosure of its full scope or all of its features.

At least one example embodiment is directed to a modular pole and canopy assembly.

In at least one example embodiment, the modular pole and canopy assembly may include a pole sub-assembly including a first segment and a second segment, the first and second segments being couplable to one another. The modular pole and canopy assembly may also include a canopy sub-assembly including a plurality of framing supports and a plurality of sheets supported by the plurality of framing supports, one or more of the plurality of framing supports couplable to the first segment of the pole sub-assembly.

In at least one example embodiment, the modular pole and canopy assembly may further include a sleeve that is configured to couple the first and second segments to one another.

In at least one example embodiment, the sleeve may be formed integrally with the second segment.

In at least one example embodiment, the plurality of sheets may include a central sheet and two lateral sheets configured to be positioned on opposing sides of the central sheet.

In at least one example embodiment, the plurality of framing supports may include two lateral support and two major beams. Each of the two major beams may be couplable to at least one of the lateral sheets and positioned perpendicularly to each lateral support.

In at least one example embodiment, the plurality of framing supports may include a support structure configured to support the central sheet. The support structure may have the same outer dimensions as the central sheet.

In at least one example embodiment, the plurality of framing supports may further include a canopy-pole support couplable to the support structure and configured to engage the pole sub-assembly.

In at least one example embodiment, the first segment of the pole sub-assembly may include a first mounting plate that is couplable to the canopy-pole support.

In at least one example embodiment, the second segment may include a second mounting plate that is couplable to an external base structure.

In at least one example embodiment, a first major dimension of the canopy sub-assembly may be angled relative to a second major dimension of the pole sub-assembly. An angle between the first and second major dimensions may be greater than or equal to about 10 degrees to less than or equal to about 15 degrees.

In at least one example embodiment, the modular pole and canopy assembly may further include a multi-component mounting system configured to secure a display system to the pole sub-assembly. The multi-component mounting system may include two or more vertical supports for engaging lateral edges of each of one or more display panels defining the display system, a horizonal support configured to provide a mounting structure for the two or more vertical supports, and two or more triangular couplers configured to secure the horizonal support to the pole sub-assembly.

In at least one example embodiment, the two or more triangular couplers may be couplable to the second segment.

At least one example embodiment is directed to a method for assembling a modular pole and canopy assembly.

In at least one example embodiment, the method may include securing the second mounting plate to the external base structure and securing the first mounting plate to the canopy-pole support.

In at least one example embodiment, the method may further include securing the support structure to the central sheet.

In at least one example embodiment, the method may further include securing the two major beams to the at least one of the lateral sheets.

At least another example embodiment is directed to a modular pole and canopy assembly.

In at least one example embodiment, the modular pole and canopy assembly may include a pole sub-assembly including a first segment, a second segment, and a sleeve configured to couple the first and second segments to one another. The modular pole and canopy assembly may further include a canopy sub-assembly including a plurality of framing supports and a plurality of sheets supported by the plurality of framing supports. One or more of the plurality of framing supports may be couplable to the first segment of the pole sub-assembly. The plurality of sheets may include a central sheet and two lateral sheets configured to be positioned on opposing sides of the central sheet. The plurality of framing supports may include two lateral support and two major beams. Each of the two major beams may be couplable to at least one of the lateral sheets and positioned perpendicularly to each lateral support.

In at least one example embodiment, the plurality of framing supports may include a support structure configured to support the central sheet and a canopy-pole support couplable to the support structure and configured to engage the pole sub-assembly.

In at least one example embodiment, the first segment of the pole sub-assembly may include a first mounting plate that is couplable to the canopy-pole support.

In at least one example embodiment, a first major dimension of the canopy sub-assembly may be angled relative to a second major dimension of the pole sub-assembly. An angle between the first and second major dimensions may be greater than or equal to about 10 degrees to less than or equal to about 15 degrees.

In at least one example embodiment, the modular pole and canopy assembly may further include a multi-component mounting system configured to secure a display system to the pole sub-assembly. The multi-component mounting system may include two or more vertical supports for engaging lateral edges of each of one or more display panels defining the display system, a horizonal support configured to provide a mounting structure for the two or more vertical supports, and two or more triangular couplers configured to secure the horizonal support to the pole sub-assembly.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

The present disclosure will become more fully understood from the detailed description and the accompanying drawings, wherein:

FIG. 1 is a top-down perspective view of a pole and canopy assembly in accordance with at least one example embodiment;

FIG. 2 is a bottom-up perspective view of the pole and canopy assembly of FIG. 1;

FIG. 3 is a top-down perspective view of the pole and canopy assembly of FIG. 1 as mounted on a concrete base in accordance with at least one example embodiment;

FIG. 4 is a bottom-up perspective view of the pole and canopy assembly of FIG. 1 as mounted on a concrete base in accordance with at least one example embodiment;

FIG. 5 is a top-down perspective view of the pole and canopy assembly of FIG. 1 supporting a display system in accordance with at least one example embodiment;

FIG. 6 is a bottom-up perspective view of the pole and canopy assembly of FIG. 1 supporting the display system of FIG. 5 in accordance with at least one example embodiment;

FIG. 7 is a top-down perspective view of the pole and canopy assembly of FIG. 1 and an exploded view of the display system of FIG. 5;

FIG. 8 is a bottom-up perspective view of the pole and canopy assembly of FIG. 1 and an exploded view of the display system of FIG. 5;

FIG. 9 is a top-down, exploded perspective view of a pole sub-assembly of the pole and canopy assembly of FIG. 1;

FIG. 10 is a top-down, exploded perspective view of the canopy sub-assembly of the pole and canopy assembly of FIG. 1; and

FIGS. 11A–11G are demonstrations illustrating an example method for assembling the pole and canopy assembly of FIG. 1 in accordance with at least one example embodiment.

In the drawings, reference numbers may be reused to identify similar and/or identical elements.

### DETAILED DESCRIPTION

A pole and canopy assembly is provided. The pole and canopy assembly includes a pole sub-assembly and a canopy sub-assembly, where the pole sub-assembly is couplable to the canopy sub-assembly and a major dimension of the canopy sub-assembly is angled relative to a major dimension of the pole sub-assembly and where the pole sub-assembly includes two or more components and the canopy sub-assembly includes three or more components. For example, the pole sub-assembly may include a first segment including (or couplable to) a first mounting plate for joining together the pole sub-assembly and the canopy sub-assembly and a second segment including (or couplable to) a second mounting plate for joining together the pole sub-assembly and an external base structure that maintains the pole and canopy assembly in an upright position, where a sleeve joins and secures together the first and second segments. The canopy sub-assembly may include a canopy-pole support that is configured to engage with the pole sub-assembly, two lateral sheets that are configured to be positioned on opposing sides of a central sheet, a first support structure supporting the central sheet and the lateral sheets, two lateral support further securing the lateral sheets to the first support structure and the central, and two major canopy beams that are perpendicularly coupled to the two lateral supports to provide further support to the lateral sheets. The modularity of the different sub-assemblies of the pole and canopy assembly allows the pole and canopy assembly to be easily transported and also assembled while suspended by two team members. In addition, the canopy includes various features, such as staggered or overlapping frames, panels, or sheets and strengthening ribs, channels, or beams that provide sufficient structural integrity to withstand various weather (e.g., wind).

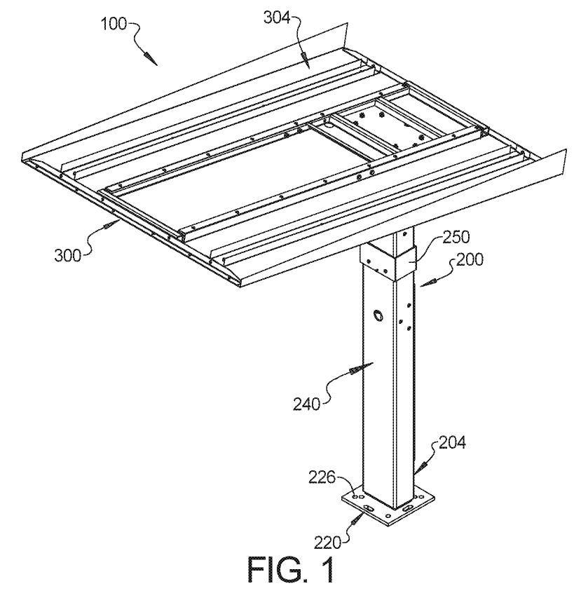

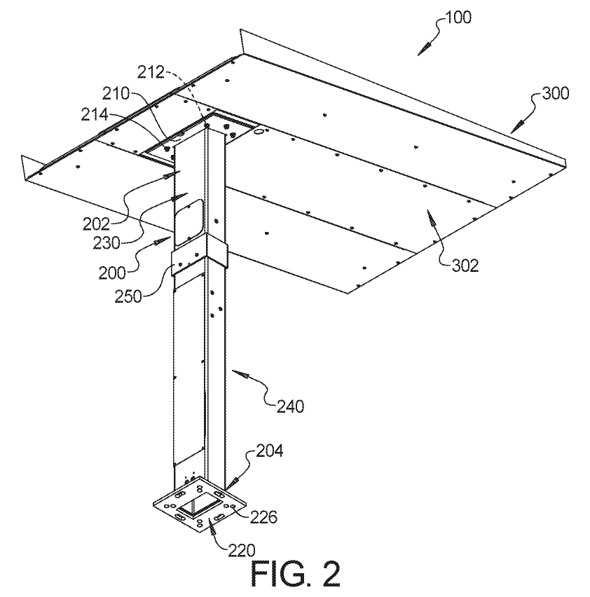

FIG. 1 is a top-down perspective view of a pole and canopy assembly 100, and FIG. 2 is a bottom-up perspective view of the pole and canopy assembly 100. The pole and canopy assembly 100 includes a pole sub-assembly 200 and a canopy sub-assembly 300, where a first end 202 of the pole sub-assembly 200 is couplable to the canopy sub-assembly 300. The canopy sub-assembly 300 has opposing first and second sides 302, 304, where the first side 302 of the canopy sub-assembly faces the pole sub-assembly 200 and has a substantially smooth appearance and surface, and the second side 304 of the canopy sub-assembly faces away from the pole sub-assembly 200 and includes the modular hardware for the canopy sub-assembly 300, as further discussed below. A major dimension (e.g., length) or surface (e.g., surface of the side 302 or 304) of the canopy sub-assembly 300 is angled relative to a major dimension (e.g., length) or surface (e.g., surface to which leader line for element 200 or 240 points in FIG. 1) of the pole sub-assembly 200. In at least one example embodiment, the angle between the major dimension or surface of the canopy sub-assembly 300 to the major dimension or surface of the pole sub-assembly 200 may be sufficient to allow for water drainage. In at least one example embodiment, the angle between the major dimension or surface of the canopy sub-assembly 300 to the major dimension or surface of the pole sub-assembly 200 may be greater than or equal to about 10 degrees to less than or equal to about 15 degrees.

In at least one example embodiment, the first end 202 of the pole sub-assembly 200 may include a first mounting plate 210 for securing together the pole sub-assembly 200 and the canopy sub-assembly 300. For example, the first mounting plate 210 may include define a plurality of apertures 212 that are configured to receive a plurality of fasteners (e.g., screws or bolts) 214 that also extend through corresponding apertures of or from the canopy sub-assembly 300 to secure together the pole sub-assembly 200 and the canopy sub-assembly 300. In at least one example embodiment, the first mounting plate 210 may be formed integrally with the first end 202 of the pole sub-assembly 200. In other example embodiment, the first mounting plate 210 may be formed separately from and subsequently coupled to the first end 202 of the pole sub-assembly 200. For example, the first mounting plate 210 may be welded to the first end 202 of the pole sub-assembly 200.

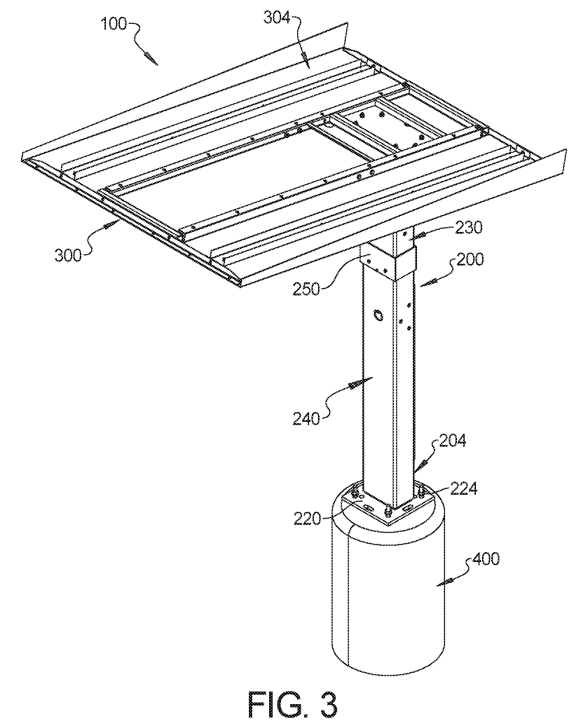

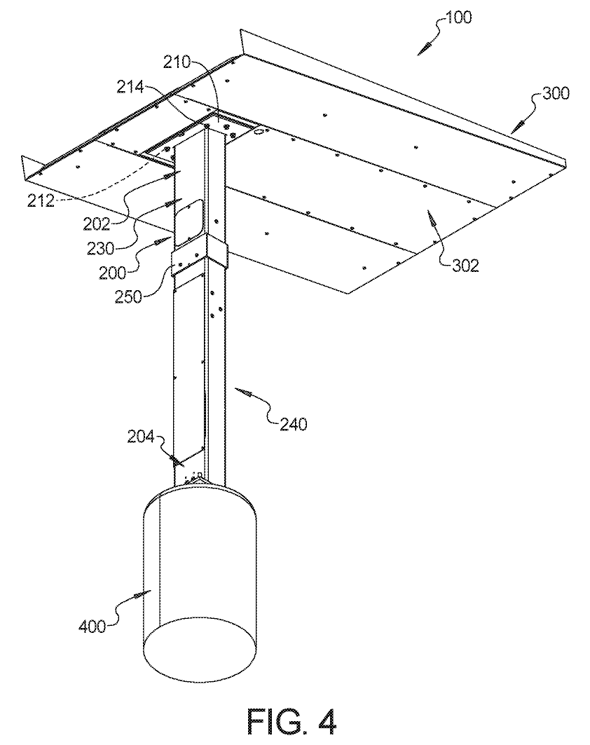

A second end 204 of the pole sub-assembly 200 away from the first end 202 is couplable to a concrete base 400 such that the pole and canopy assembly 100 may be maintained in an upright position. For example, FIG. 3 is a top-down perspective view of the pole and canopy assembly 100 as mounted on the concrete base 400, and FIG. 4 is a bottom-up perspective view of the pole and canopy assembly 100 as mounted on the concrete base 400. Although the concrete base 400 is illustrated as having a circular cross-sectional configuration, it should be appreciated that, in various example embodiments, the concrete base 400 may have a different cross-sectional configuration, including, for example only, square, rectangular, or oval. Further, although a concrete base 400 is illustrated, it should be appreciated that, in various example embodiments, the second end 204 of the pole sub-assembly 200 may be similarly mounted to other structures for the purposes of maintaining the pole and canopy assembly 100 in the upright position.

In at least one example embodiment, the second end 204 of pole sub-assembly 200 may include a second mounting plate 220 for securing the pole sub-assembly 200 to the concrete base 400 (or other supporting base). For example, the second mounting plate 220 may include define a plurality of apertures 226 that are configured to receive a plurality of fasteners (e.g., screws or bolts or anchors) 224 that also extend through or from corresponding apertures or from the concrete base 400 (or other supporting base) or that are set within and extend from the concrete base 400 (or other supporting base) to secure together the pole sub-assembly 200 and the concrete base 400 (or other supporting base). In at least one example embodiment, the second mounting plate 220 may be formed integrally with the second end 204 of the pole sub-assembly 200. In other example embodiment, the second mounting plate 220 may be formed separately from and subsequently coupled to the second end 204 of the pole sub-assembly 200. For example, the second mounting plate 220 may be welded to the second end 202 of the pole sub-assembly 200.

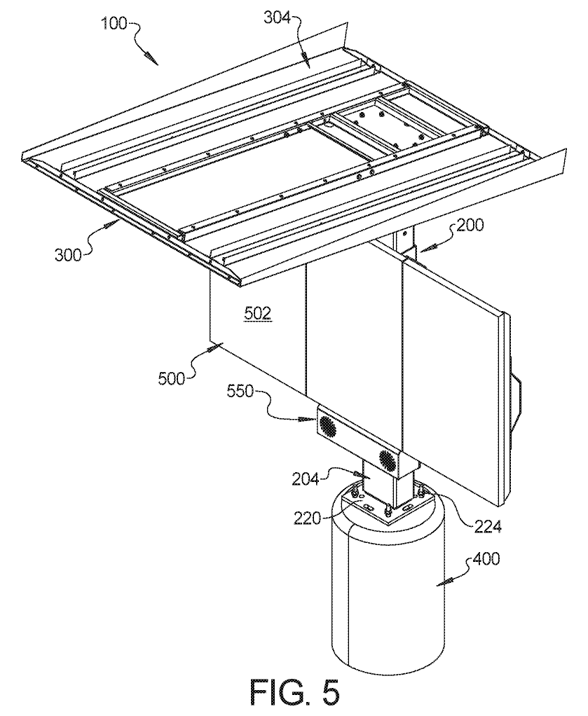

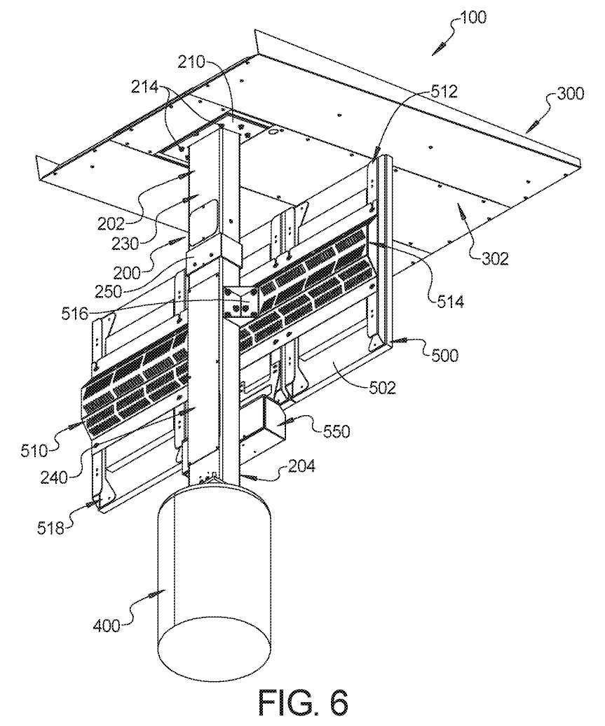

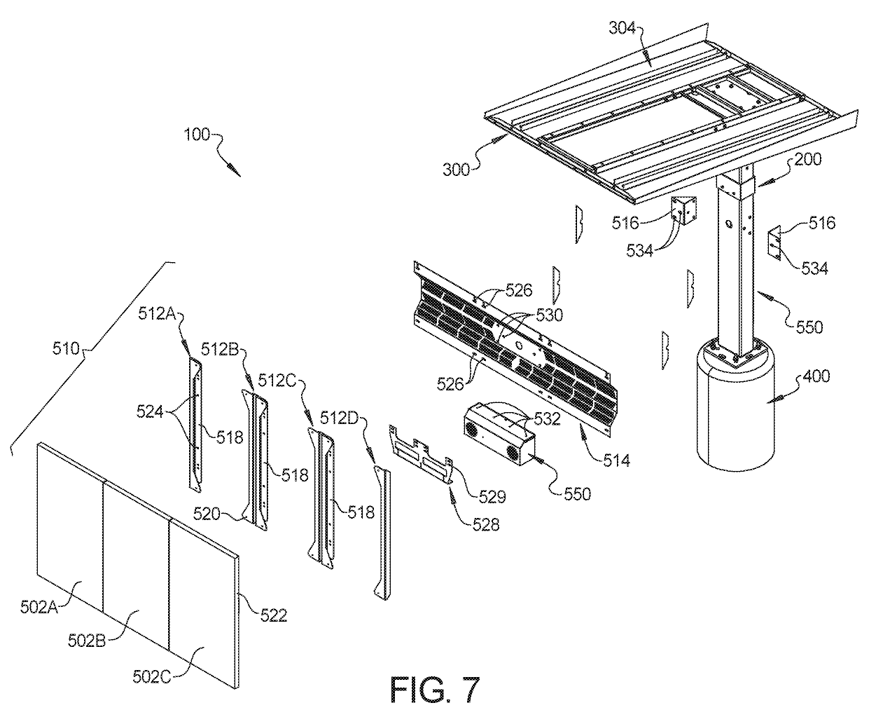

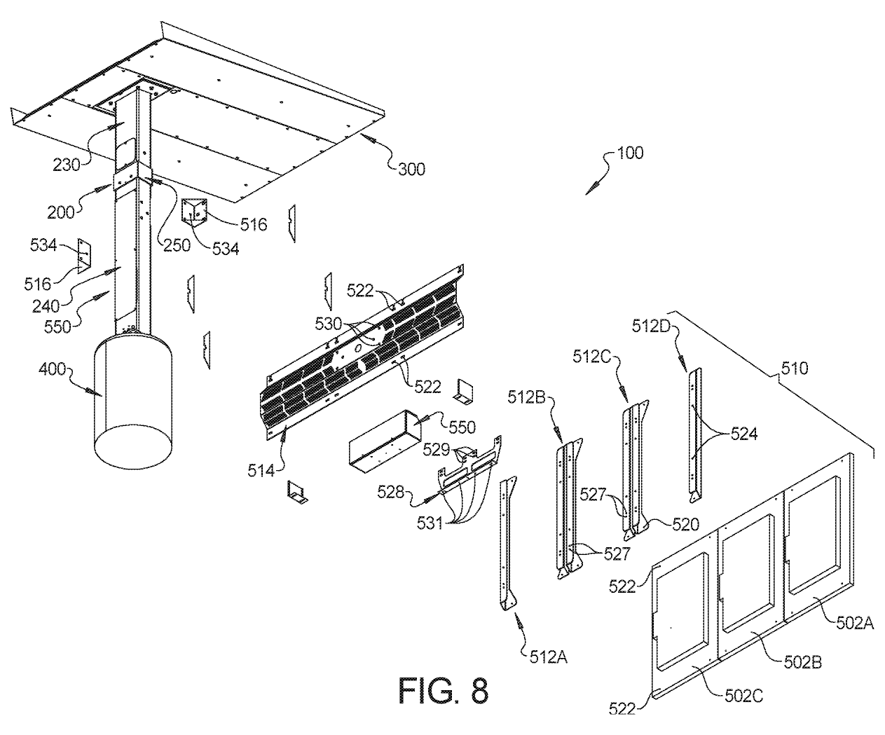

In at least one example embodiment, the pole and canopy assembly 100 may support a display system 500. For example, FIG. 5 is a top-down perspective view of the pole and canopy assembly 100 supporting the display system 500, FIG. 6 is a bottom-up perspective view of the pole and canopy assembly 100 supporting the display system 500, FIG. 7 is a top-down perspective view of the pole and canopy assembly 100 and an exploded view of the display system 500, and FIG. 8 is a bottom-up perspective view of the pole and canopy assembly 100 and the exploded view of the display system 500. The display system 500 includes one or more display panels 502 that are mounted to the pole sub-assembly 200 using a multi-component mounting system 510. The display panels 502 may include one or more monitors (e.g., liquid-crystal display) and/or one or more static images that may be lit from behind and/or the sides. In at least one example embodiment, the display system 500 may also include a speaker assembly 550. The speaker assembly 550 may be part of a two-way intercom system. The speaker assembly 550 may be mounted below the display panels 502 using the same multi-component mounting system 510.

The multi-component mounting system 510 may include a two or more vertical supports 512 for engaging the lateral edges of each respective display panels 502, a horizonal support 514 that provides a mounting structure to the two or more vertical supports 512, and two or more triangular couplers 516 for securing the horizonal support 514 to the pole sub-assembly 200.

When the display system 500 includes three display panels 502, as illustrated, the mounting system 510 ay include four vertical supports 512, where a first vertical support 512A engages a first lateral edge of a first display panel 502A, a second vertical support 512B engages a second lateral edge of the first display panel 502A and also a first lateral edge of a second display panel 502B, a third vertical support 512C engages a second lateral edge of the second display panel 502B and also a first lateral edge of a third display panel 502C, and a fourth vertical support 512D engages a second lateral edge of the third display panel 502C. In each instance, the two or more vertical supports 512 may define one or more pockets or channels 518 for receiving the respective display panel 502 or a portion thereof.

The two or more vertical supports 512 may define a plurality of apertures 520 that are configured to receive a plurality of fasteners that also extend through corresponding apertures 522 of or from the respective display panel 502 to secure together the respective vertical supports 512 and display panels 502. The two or more vertical supports 512 may define a plurality of apertures 524 that are configured to receive a plurality of fasteners that also extend through corresponding apertures (a first plurality of apertures) 526 of or from the horizonal support 514 to secure the vertical supports 512 to the horizonal support 514. The two or more vertical supports 512 may also include a plurality of apertures 527 that are configured to receive a plurality of fasteners that also extend through corresponding apertures 529 of a second horizontal support 528 to secure the second horizontal support 528 to the first horizontal support 514. The second horizontal support 528 may include a plurality of apertures 531 that are configured to receive a plurality of fasteners that also extend through corresponding apertures 532 of the speaker assembly 550 to secure the speaker assembly 550 to the second horizontal support 528. The horizontal support 514 may include a plurality of apertures 530 that are configured to receive a plurality of fasteners that also extend through corresponding apertures 534 or from the respective triangular coupler 516 to secure the horizontal support 514 to the triangular couplers 516. Each of the triangular couplers 526 may further a plurality of apertures that are configured to receive a fifth plurality of fasteners that also extend through corresponding apertures of or from the post sub-assembly 200 to secure the triangular couplers 516 to the post sub-assembly 200. For example, as illustrated the individual triangular couplers 516 may be disposed on opposing sides of the post sub-assembly 200.

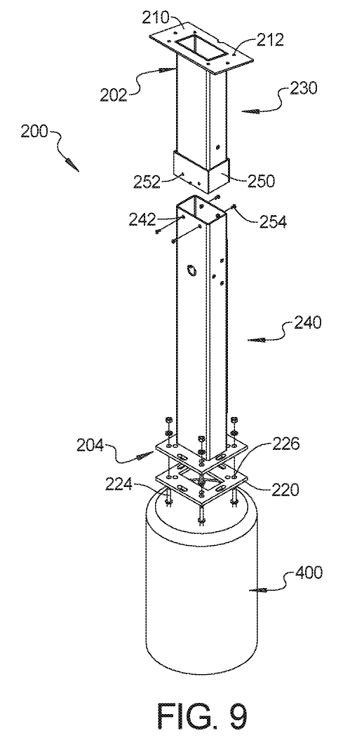

FIG. 9 is a top-down, exploded perspective view of the pole sub-assembly 200. The pole sub-assembly 200 includes a first (or top) segment 230 and a second (or bottom) segment 240, where the first segment 230 defines the first end 202 of the pole sub-assembly 200 and includes or is couplable to the first mounting plate 210 and the second segment 240 defines the second end 204 of the pole sub-assembly 200 and includes or is couplable to the second mounting plate 220. In at least one example embodiment, the first and second segments 230, 240 may each be hollow-formed tubes having a general rounded-corner, rectangular cross-sectional configuration. Although the first and second segments 230, 240 are illustrated as having a general rounded-corner, rectangular cross-sectional configuration, it should be appreciated, that in various example embodiments, the first and second segments 230, 240 may have a different cross-sectional configuration, including, for example only, circular, square, or oval. In at least one example embodiment, the first and second segments 230, 240 may be prepared using A500 HS steel that is powder coated to limit rust.

The pole sub-assembly 200 includes a sleeve 250 for joining together the first and second segments 230, 240. For example, the sleeve 250 may be configured to receive a portion of the first segment 230 away from the first end 202 and a portion of the second segment 240 away from the second end 204. The sleeve 250 may have a first length, while the first segment 230 has a second length and the second segment 240 has a third length. In at least one example embodiment, equal portions of the sleeve 250 may engage with respective portions of the first and second segments 230, 240. That is, a first portion of the sleeve 250 that engages with the first segment 230 may have a first dimension and a second portion of the sleeve 250 that engages with the second segment 240 may have a second dimension, and the first and second dimensions may be the same. In at least one example embodiment, the first length of the sleeve 250 may be greater than or equal to about 15 percent to less than or equal to about 25 percent (e.g., about 20 percent) of a total length of the first segment 230 (i.e., the second length). In at least one example embodiment, the first length of the sleeve 250 may be greater than or equal to about 5 percent to less than or equal to about 15 percent (e.g., about 10 percent) of a total length of the second segment 240 (i.e., the third length).

In at least one example embodiment, the sleeve 250 may be provided with the first segment 230. For example, the sleeve 250 may be formed integrally with the first segment 230. In other example embodiments, the sleeve 250 may be separately formed and subsequently coupled to the first segment 230. For example, the sleeve 250 may be welded to the first segment 230. The joining of the sleeve 250 to the first segment 230 (as opposed to the second segment 240) may help to control water flow (e.g., to prevent water to run into a top of the sleeve 250). The sleeve 250 may include a plurality of apertures 252 that are configured to receive a plurality of fasteners 254 that also extend through corresponding apertures 242 of or from the second segment 240 to secure together the sleeve 250 and the second segment. In various implementations, the assembly 100 may be used without the first segment 230 and the canopy sub-assembly 300 (e.g., to support the display system 500), and a cap (not shown) may be placed over the sleeve 250 and/or exposed end of the second segment 240 opposite of the second end 204.

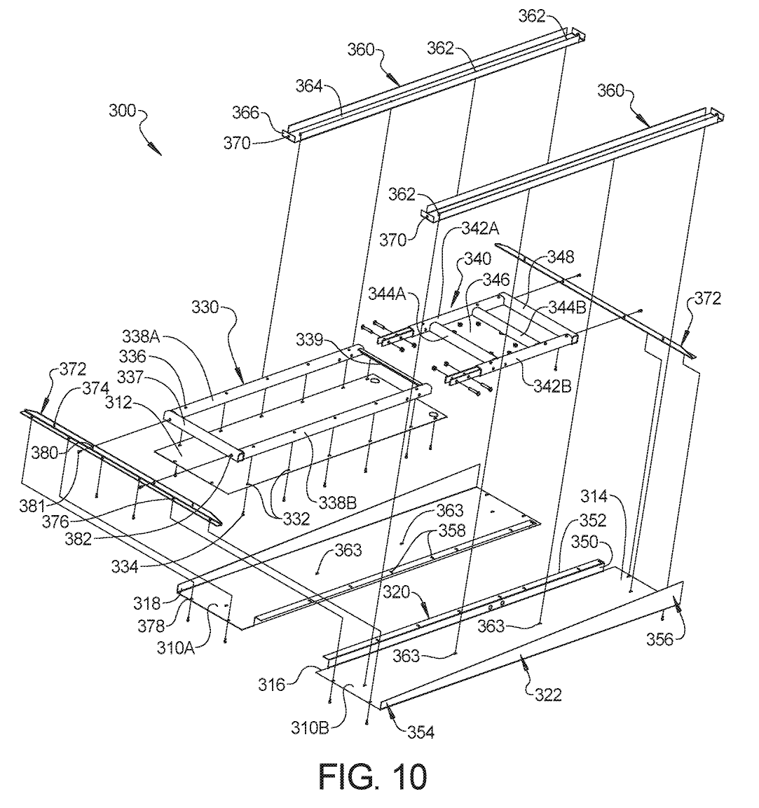

FIG. 10 is a top-down, exploded perspective view of the canopy sub-assembly 300 of the pole and canopy assembly 100. The canopy sub-assembly 300 includes a canopy-pole support 340 that is configured to engage with the pole sub-assembly 200, and in particular, for example, the first mounting plate 210. The canopy-pole support 340 may include an asymmetrical frame that includes one or more beams that are couplable together or integrally formed. For example, the canopy-pole support 340 may include opposing first and second beams 342A, 342B and third and fourth beams 344A, 344B that extend between the first and second beams 342A, 342B to support a third mounting plate 346 and a fifth beam 348 that extends over terminating ends of the first and second beams 342A, 342B and where ends of the first and second beams 342A, 342B away from the terminating ends are exposed. It should be appreciated that like the other systems detailed herein the beams 342, 342B, 344A, 344B, 348 and also the third mounting plate 346 may include corresponding apertures configured to receive or support one or more fasteners. The corresponding apertures and the fasteners configured to secure together the beams 342, 342B, 344A, 344B, 348 and also the third mounting plate 346.

The canopy sub-assembly 300 includes two lateral sheets 310A, 310B that are configured to be positioned on opposing sides of a central sheet 312. The central sheet 312 may be substantially planar and couplable to a support structure 330. The central sheet 312 and the support structure 330 may have the same or similar outer dimension. For example, the support structure 330 may include one or more beams that are couplable together or integrally formed that together correspond with and are couplable to a parameter of the central sheet 312. For example, the support structure 330 may include first and second beams 338A, 338B, a third beam 337 that extends over terminating ends of the first and second beams 338A, 338B, and a fourth beam 339 that extends between ends of the first and second beams 338A, 338B away from the terminating ends. The first and second beams 338A, 338B of the support structure 330 may be configured to receive the exposed ends of the first and second beams 342A, 342B of the canopy-pole support 340. The central sheet 312 may define a plurality of apertures 332 that are configured to receive a plurality of fasteners 334 that also extend through corresponding apertures 336 of or from the support structure 330 and corresponding apertures 358 in the lateral sheets 310A, 310B to secure together the central sheet 312, the lateral sheets 310A, 310B, and the support structure 330.

Each of the lateral sheets 310A, 310B includes a planar surface 314 with a flange or lip 320 extending from a first length (or side) 316 of the planar surface 314 and a flap 322 extending from a second length (or side) 318 of the planar surface 314. The flap 322 may be an asymmetrical component that extends substantially perpendicular to the planar surface 314. For example, a first end 354 of the flap 322 may have a first height and a second end 356 of the flap 322 may have a second height that is greater than the first height and the flap 322 may be sloped between the first end 354 and the second end 356. The lip 320 may include a first vertical component 350 that extends substantially perpendicular to the planar surface 314 and a horizontal extending component 352 that extends substantially perpendicularly from an end of the lip 320 away from the planar surface 314 and extends substantially parallel to the planar surface 314. The horizontal extending component 352 of the lip 320 includes the apertures 358 for receiving fasteners to secure the lateral sheets 310A, 310B to the central sheet 312 and the support structure 330.

The canopy sub-assembly 300 may include two or more major canopy beams 360 may include a plurality of apertures 362 that correspond with and are configured to receive fasteners that also extend through corresponding apertures 363 in the planar surfaces 314 of the lateral sheets 310A, 310B to secure the two or more major canopy beams 360 to the lateral sheets 310A, 310B. Each of the two or more major canopy beams 360 may have a bottom or base component 364 and a plurality of sides 366 extending substantially perpendicularly therefrom. The apertures 362 are defined in the base component 364 of the major canopy beam 360. Two or more of the plurality of sides 366 extend from opposing first and second ends of the major canopy beam 360 and may include apertures 370 for coupling the major canopy beam 360 to two lateral supports 372.

The lateral supports 372 may each include a first plurality of apertures 374 that correspond with and are configured to receive fasteners that also extend through the corresponding aperture 370 of each of the major canopy beams 360 (i.e., each lateral support 372 is couplable to each major canopy beam 360 and each major canopy beam 360 is couplable to each lateral support 372). The lateral supports 372 may each further include a second plurality of apertures 376 that correspond with and are configured to receive fasteners that also extend through or from the corresponding apertures 378 of each lateral sheet 310A, 310B. Further still, the lateral supports 372 may each further include a plurality of apertures 380 that correspond with and are configured to receive fasteners that also extend through or from the corresponding apertures 382 of the third beam 337.

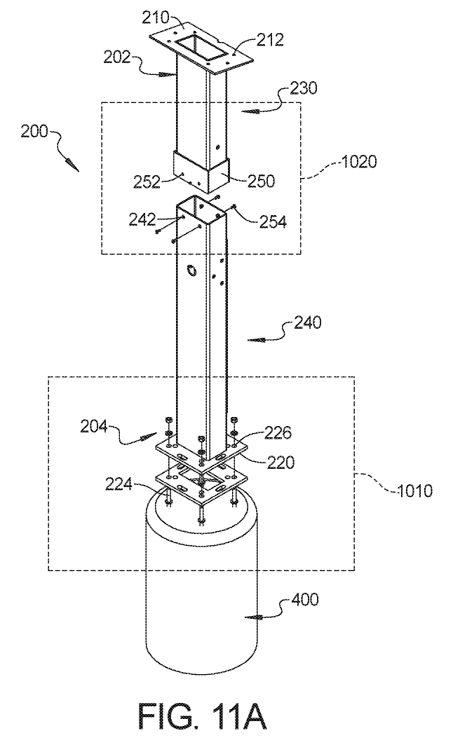

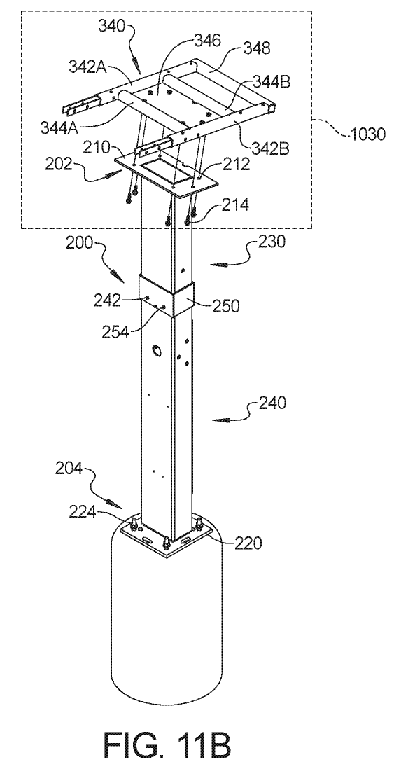

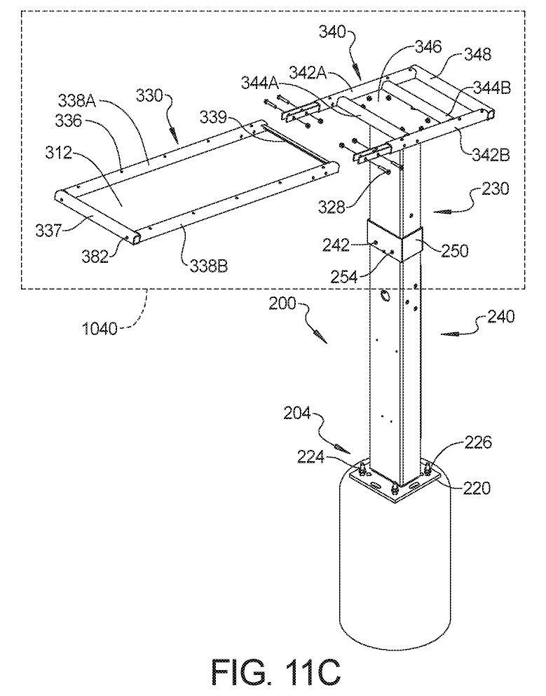

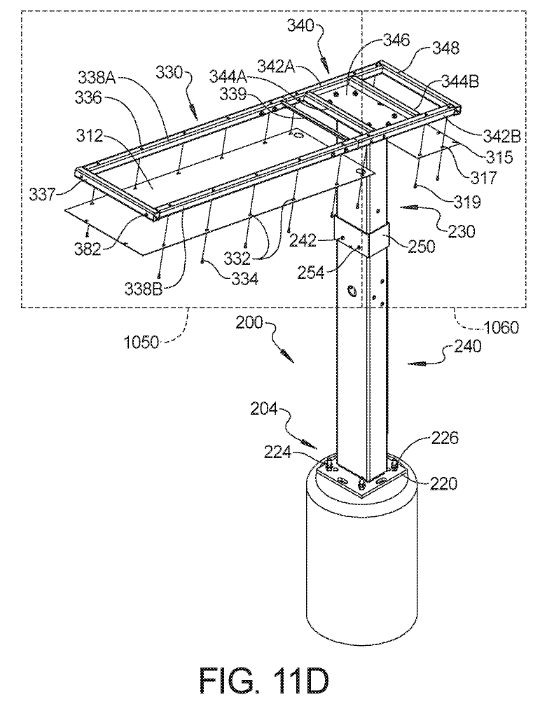

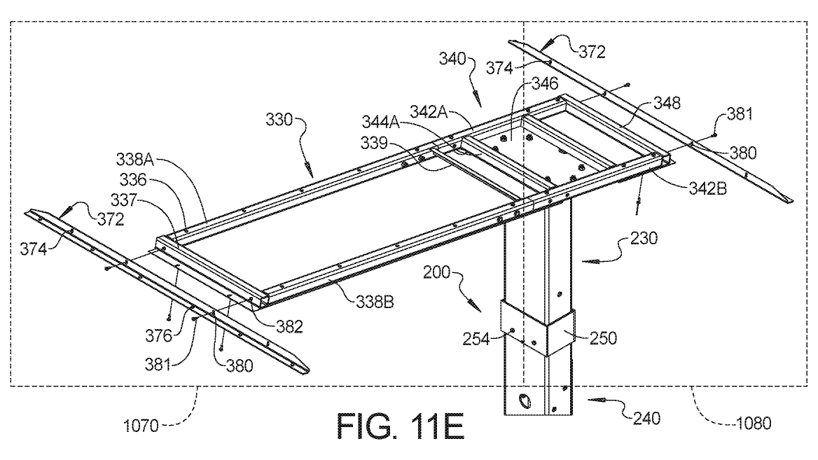

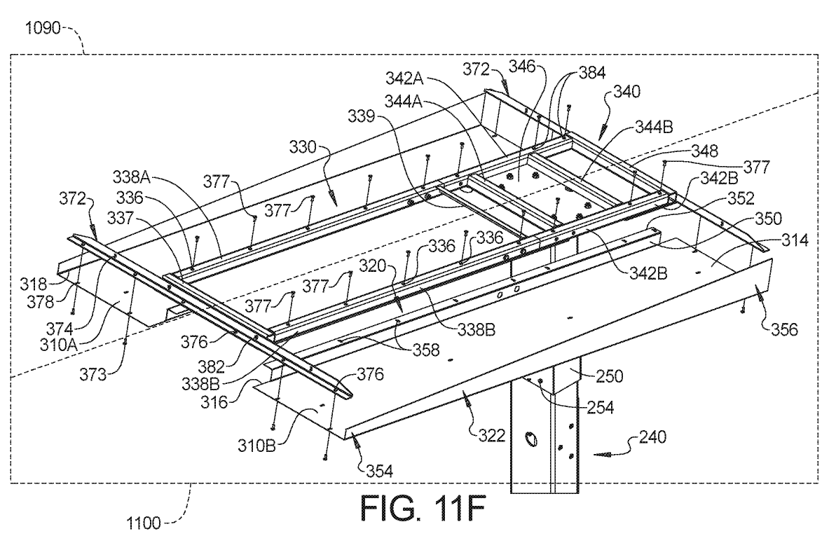

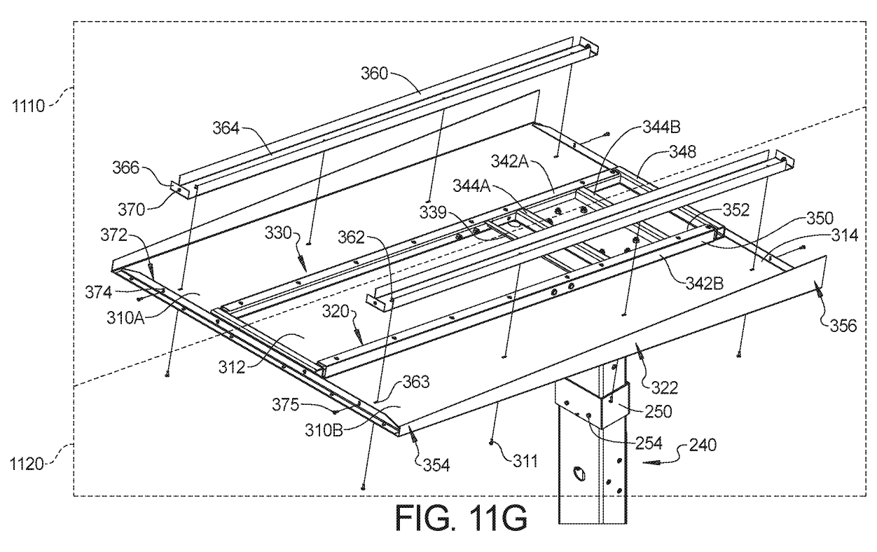

FIGS. 11A–11G are demonstrations illustrating an example method 1000 for assembling the pole and canopy assembly 100.

The method 1000 may include, as illustrated in FIG. 11A, securing 1010 the pole sub-assembly 200 to the concrete base 400. More specifically, the method 1000 may include securing 1010 the second mounting plate 220 as attached to or formed with the second segment 240 of the sub-assembly 200. The pole sub-assembly 200 may be secured to the concrete base 400 when the fasteners 224 extending from the concrete base 400 are received by the apertures 226 of the second mounting plate 220.

The method 1000 may include, as also illustrated in FIG. 11B, securing 1020 together the first and second segments 230, 240 of the pole sub-assembly 200. The securing 1020 may include moving the sleeve 250 as formed integrally with, or coupled to, the first segment 230 over the second segment 240, aligning the apertures 252 of the sleeve 250 and the apertures 242 of the second segment 240, and moving a fastener 254 through the aligned apertures 252, 254.

The method 1000 may include, as illustrated in FIG. 11B, securing 1030 together the canopy-pole support 340 and the first end 202 of the pole sub-assembly 200. More specifically, the method 1000 may include securing 1030 together the canopy-pole support 340 and the first mounting plate 210 as attached to or formed with the first segment 230 of the pole sub-assembly 200. The canopy-pole support 340 and the first end 202 of the pole sub-assembly 200 may be secured together when the fasteners 214 are received by corresponding apertures 212 of the first mounting plate 210 and the canopy-pole support 340. Although not illustrated, it should be appreciated that, in various example embodiments, the method 1000 may include assembling the canopy-pole support 340. For example, the method 1000 may include joining together the third and fourth beams 344A, 344B to the first and second beams 342A, 342B and/or joining together the third and fourth beams 344A, 344B and/or the first and second beams 342A, 342B to third mounting plate 346 and/or joining together the first and second beams 342A, 342B to the fifth beam 348.

The method 1000 may include, as illustrated in FIG. 11C, securing 1040 together the support structure 330 and the canopy-pole support 340. The securing 1040 may include aligning the support structure 330 to receive the exposed ends of the first and second beams 342A, 342B of the canopy-pole support 340 and joining together the support structure 330 and the canopy-pole support 340 using one or more fasteners 328. Although not illustrated, it should be appreciated that, in various example embodiments, the method 1000 may include assembling the support structure 330. For example, the method 1000 may include joining together the first and second beams 338A, 338B and the third beam 337, and/or joining together the first and second beams 338A, 338B and the fourth beam 339.

The method 1000 includes, as illustrated in FIG. 11D, securing 1050 the central sheet 312 to the support structure 330 and/or securing 1060 another sheet 315 to the canopy-pole support 340. The securing 1050 may include aligning apertures 332 of the central sheet 312 with corresponding apertures of the support structure 330 and joining together the central sheet 312 and the support structure 330 using fasteners 334.The securing 1060 may include aligning apertures 317 of the other sheet 315 with corresponding apertures of the canopy-pole support 340 and joining together the other sheet 315 and the canopy-pole support 340 using fasteners 319.

The method 1000 includes, as illustrated in FIG. 11E, securing 1070 a first lateral support 372 to the support structure 330 and securing 1080 a second lateral support 372 to the canopy-pole support 340. The securing 1070 may include aligning apertures 380 of the first lateral support 372 with corresponding apertures 382 of the third beam 337 of the support structure 330 and joining together the first lateral support 372 and the third beam 337 of the support structure 330 using fasteners 381. The securing 1080 may include aligning apertures 380 of the second lateral support 372 with corresponding apertures of the fifth beam 348 of the canopy-pole support 340 and joining together the second lateral support 372 and the fifth beam 348 of the canopy-pole support 340 using fasteners 381.

The method 1000 includes, as illustrated in FIG. 11F, securing 1090 the first lateral sheet 310A to first portions of the as-secured first and second lateral supports 372 and securing 1100 the second lateral sheet 310B to second portions of the as-secured first and second lateral supports 372. More specifically, the method 1000 may include aligning the apertures 378 of the first and second lateral sheets 310A, 310B with the corresponding apertures 376 of the first and second lateral supports 372 and joining together the first and second lateral sheets 310A, 310B to the respective portions of the first and second lateral supports 372 using fasteners 373.

The method 1000 may also include securing the first and second lateral sheets 310A, 310B to the support structure 330 and the canopy-pole support 340. More specifically, the method 1000 may include aligning the apertures 358 in the lateral sheets 310A, 310B with the corresponding apertures 336 in the support structure 330 and corresponding apertures 384 in the canopy-pole support 340 and joining together the first and second lateral sheets 310A, 310B to the support structure 330 and the canopy-pole support 340 using fasteners 377. In various implementations, the fasteners 334 used to secure the central sheet 312 to the support structure 330 as shown in FIG. 11D and the fasteners 377 used to secure the first and second lateral sheets 310A, 310B to the first support structure 330 as shown in FIG. 11F may be replaced with a single set of fasteners that extend through the apertures 358 in the lateral sheets 310A, 310B, through the apertures 336 in the first support structure 330, and through the apertures 332 in the central sheet 312.

The method 1000 includes, as illustrated in FIG. 11G, securing 1110 the first major canopy beam 360 to the first lateral sheet 310A and to first portions of the first and second lateral supports 372 and securing 1120 the second major canopy beam 360 to the second lateral sheet 310B and to second portions of the first and second lateral supports 372. The securing 1110 may include aligning the base apertures 362 of the respective major canopy beam 360 with the corresponding apertures 363 of the respective lateral sheet 310A, 310B and joining together each major canopy beam 360 and the respective lateral sheet 310A, 310B using fasteners 311. The securing 1020 may include aligning side apertures 370 of the respective major canopy beam 360 with corresponding apertures 374 of the respective portions of the lateral supports 372 and joining together the respective major canopy beam 360 and lateral supports 372 using fasteners 375.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

What is claimed is:

1. A modular pole and canopy assembly comprising:
a pole sub-assembly including a first segment and a second segment, the first and second segments being couplable to one another; and
a canopy sub-assembly including a plurality of framing supports and a plurality of sheets supported by the plurality of framing supports, one or more of the plurality of framing supports being couplable to the first segment of the pole sub-assembly.

2. The modular pole and canopy assembly of claim 1, further comprising a sleeve configured to couple the first and second segments to one another.

3. The modular pole and canopy assembly of claim 2, wherein the sleeve is formed integrally with the second segment.

4. The modular pole and canopy assembly of claim 1, wherein the plurality of sheets includes a central sheet and two lateral sheets configured to be positioned on opposing sides of the central sheet.

5. The modular pole and canopy assembly of claim 4, wherein the plurality of framing supports includes two lateral support and two major beams, each of the two major beams being couplable to at least one of the lateral sheets and positioned perpendicularly to each lateral support.

6. The modular pole and canopy assembly of claim 5, wherein the plurality of framing supports includes a support structure configured to support the central sheet, the support structure having the same outer dimensions as the central sheet.

7. The modular pole and canopy assembly of claim 6, wherein the plurality of framing supports further includes a canopy-pole support couplable to the support structure and configured to engage the pole sub-assembly.

8. The modular pole and canopy assembly of claim 7, wherein the first segment of the pole sub-assembly includes a first mounting plate that is couplable to the canopy-pole support.

9. The modular pole and canopy assembly of claim 8, wherein the second segment includes a second mounting plate that is couplable to an external base structure.

10. A method for assembling the modular pole and canopy assembly of claim 9, the method comprising:
securing the second mounting plate to the external base structure; and
securing the first mounting plate to the canopy-pole support.

11. The method of claim 10, wherein the method further comprises securing the support structure to the central sheet.

12. The method of claim 10, wherein the method further comprises securing the two major beams to the at least one of the lateral sheets.

13. The modular pole and canopy assembly of claim 1, wherein a first major dimension of the canopy sub-assembly is angled relative to a second major dimension of the pole sub-assembly, an angle between the first and second major dimensions being greater than or equal to about 10 degrees to less than or equal to about 15 degrees.

14. The modular pole and canopy assembly of claim 1, further comprising:
a multi-component mounting system configured to secure a display system to the pole sub-assembly, the multi-component mounting system including
two or more vertical supports for engaging lateral edges of each of one or more display panels defining the display system,
a horizonal support configured to provide a mounting structure for the two or more vertical supports, and
two or more triangular couplers configured to secure the horizonal support to the pole sub-assembly.

15. The modular pole and canopy assembly of claim 14, wherein the two or more triangular couplers are couplable to the second segment.

16. A modular pole and canopy assembly comprising:
a pole sub-assembly including a first segment, a second segment, and a sleeve configured to couple the first and second segments to one another; and
a canopy sub-assembly including a plurality of framing supports and a plurality of sheets supported by the plurality of framing supports, one or more of the plurality of framing supports being couplable to the first segment of the pole sub-assembly, the plurality of sheets including a central sheet and two lateral sheets configured to be positioned on opposing sides of the central sheet, the plurality of framing supports including two lateral support and two major beams, each of the two major beams couplable to at least one of the lateral sheets and positioned perpendicularly to each lateral support.

17. The modular pole and canopy assembly of claim 16, wherein the plurality of framing supports includes a support structure configured to support the central sheet and a canopy-pole support couplable to the support structure and configured to engage the pole sub-assembly.

18. The modular pole and canopy assembly of claim 17, wherein the first segment of the pole sub-assembly includes a first mounting plate that is couplable to the canopy-pole support.

19. The modular pole and canopy assembly of claim 16, wherein a first major dimension of the canopy sub-assembly is angled relative to a second major dimension of the pole sub-assembly, an angle between the first and second major dimensions being greater than or equal to about 10 degrees to less than or equal to about 15 degrees.

20. The modular pole and canopy assembly of claim 16, further comprising:
a multi-component mounting system configured to secure a display system to the pole sub-assembly, the multi-component mounting system including
two or more vertical supports for engaging lateral edges of each of one or more display panels defining the display system,
a horizonal support configured to provide a mounting structure for the two or more vertical supports, and
two or more triangular couplers configured to secure the horizonal support to the pole sub-assembly.
